(19) United States
(12) Patent Application Publication
(10) Pub. No.: US 2006/0278132 A1
(43) Pub. Date: Dec. 14, 2006

(54) Method of improving dispersant efficacy in making gypsum products

(75) Inventors: Qiang Yu, Grayslake, IL (US); Michael R. Lynn, Arlington Heights, IL (US); Weixin D. Song, Lake Forest, IL (US); Qingxia Liu, Vernon Hills, IL (US); Michael P. Shake, Johnsburg, IL (US); Frederick T. Jones, Grayslake, IL (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: UNITED STATES GYPSUM COMPANY, Chicago, IL (US)

(21) Appl. No.: 11/445,906

(22) Filed: Jun. 2, 2006

Related U.S. Application Data
(60) Provisional application No. 60/688,839, filed on Jun. 9, 2005.

(51) Int. Cl. C04B 28/14; C04B 11/00

(52) U.S. Cl. 106/772; 106/778; 106/783; 106/785

(57) ABSTRACT

The invention generally provides gypsum-containing slurries including stucco, trimetaphosphate salt, and naphthalenesulfonate dispersant, wherein the trimetaphosphate salt is present in an amount of at least about 0.12% by weight based on the weight of stucco. Other slurry additives can include accelerators, binders, starch, and paper fiber, glass fiber, and other known ingredients. The invention also comprises the gypsum-containing products made with such slurries, for example, gypsum wallboard, and a method of making gypsum wallboard.

This application claims the benefit of U.S. Provisional Application No. 60/688,839, filed Jun. 9, 2005, the entire disclosure of which is hereby incorporated by reference herein.

### FIELD OF THE INVENTION

This invention pertains to a method of reducing water requirements in slurries used to make gypsum-containing products and more particularly to gypsum slurries containing a trimetaphosphate salt and a naphthalenesulfonate dispersant, and products made therefrom. It also pertains to a method of increasing dry strength of gypsum-containing products including wallboard by using a trimetaphosphate salt and a naphthalenesulfonate dispersant.

### BACKGROUND OF THE INVENTION

Certain properties of gypsum (calcium sulfate dihydrate) make it very popular for use in making industrial and building products, such as gypsum wallboard. Gypsum is a plentiful and generally inexpensive raw material which, through a process of dehydration and rehydration, can be cast, molded or otherwise formed into useful shapes. The base material from which gypsum wallboard and other gypsum products are manufactured is the hemihydrate form of calcium sulfate (CaSO₄.½H₂O), commonly termed “stucco,” which is produced by heat conversion of the dihydrate form of calcium sulfate (CaSO₄.2H₂O), from which 1½ water molecules been removed.

Conventional gypsum-containing products such as gypsum wallboard have many advantages, such as low cost and easy workability. Various improvements have been achieved in making gypsum-containing products using trimetaphosphate salts as one of the ingredients in the slurries used to make such products. For example, trimetaphosphate salts, such as sodium trimetaphosphate, increase compressive strength of gypsum-containing products including gypsum wallboard. Sodium trimetaphosphate and other trimetaphosphate salts have not in the past been used in such applications at levels higher than about 0.08% by weight based on the weight of stucco.

It is necessary to use substantial amounts of water in gypsum slurries in order to ensure proper flowability of the slurry. Unfortunately, most of this water must eventually be driven off by heating, which is expensive due to the high cost of the fuels used in the heating process. The heating step is also time-consuming. Trimetaphosphate salts have not in the past been recognized to affect gypsum slurry water requirements. However, the present inventors have discovered that increasing the level of the trimetaphosphate salt to hitherto unknown levels in the presence of a specific dispersant makes it possible to achieve proper slurry flowability with unexpectedly reduced amounts of water. This, of course, is highly desirable because it in turn reduces fuel usage as well as the process time associated with subsequent water removal process steps. The present inventors have also discovered that the dry strength of gypsum board can be increased by using the trimetaphosphate plus naphthalenesulfonate dispersant.

### BRIEF SUMMARY OF THE INVENTION

The invention generally comprises a slurry including stucco, trimetaphosphate salt, and naphthalenesulfonate dispersant. The sodium trimetaphosphate is present in an amount of at least about 0.12% by weight based on the weight of stucco. In a preferred embodiment, the trimetaphosphate salt is present in an amount of about 0.12-0.4% by weight based on the weight of dry stucco. The naphthalenesulfonate dispersant is present in an amount of about 0.1%-3.0% by weight based on the weight of dry stucco. Other slurry additives can include starch, accelerators, binders, paper or glass fibers and other known constituents. The invention also comprises the gypsum-containing products made with such slurries.

A preferred gypsum-containing product is gypsum wallboard. In this embodiment, the invention constitutes gypsum wallboard comprising a set gypsum composition formed between two substantially parallel cover sheets, the set gypsum composition made using the gypsum-containing slurry of water, stucco, sodium trimetaphosphate, and a naphthalenesulfonate dispersant, wherein the sodium trimetaphosphate is present in an amount of at least about 0.12% by weight based on the weight of stucco.

In another embodiment the invention constitutes a method of making gypsum wallboard by mixing a gypsum-containing slurry comprising water, stucco, sodium trimetaphosphate, and a naphthalenesulfonate dispersant, wherein the sodium trimetaphosphate is present in an amount of at least about 0.12% by weight based on the weight of stucco. The resulting gypsum-containing slurry is deposited on a first paper cover sheet, and a second paper cover sheet is placed over the deposited slurry to form a gypsum wallboard. The gypsum wallboard is cut after the gypsum-containing slurry has hardened sufficiently for cutting, and the resulting gypsum wallboard is dried. Other conventional ingredients will also be used in the slurry including, as appropriate, accelerators, binders, starch, paper fiber, glass fiber, and other known ingredients. A soap foam can be added to reduce the density of the final gypsum wallboard product.

### DETAILED DESCRIPTION OF THE INVENTION

According to one embodiment of the present invention, there are provided finished gypsum-containing products made from gypsum-containing slurries containing stucco, sodium trimetaphosphate, and a naphthalenesulfonate dispersant. Other ingredients that may be used in the slurry include starch, paper fiber, glass fiber, and accelerators. A soap foam can be added to the newly formulated gypsum-containing slurries to reduce the density of the final gypsum-containing product, for example, gypsum wallboard.

The combination of a minimum of at least about 0.12-0.4% by weight of trimetaphosphate salt and from about 0.1%-3.0% by weight naphthalenesulfonate dispersant (both based on the weight of dry stucco used in the gypsum slurry) unexpectedly and significantly increases the fluidity of the gypsum slurry. This substantially reduces the amount of water required to produce a gypsum slurry with sufficient flowability to be used in making gypsum-containing products such as gypsum wallboard. The level of trimetaphosphate salt, which is at least about twice that of standard formulations (as sodium trimetaphosphate), is believed to boost the dispersant activity of the naphthalenesulfonate dispersant. It should be noted that in all embodiments of the present invention, a combination of both naphthalenesulfonate dispersant and water-soluble metaphosphate or polyphosphate (and preferably a water-soluble trimetaphosphate) must be used.

The naphthalenesulfonate dispersants used in the present invention include polynaphthalenesulfonic acid and its salts (polynaphthalenesulfonates) and derivatives, which are condensation products of naphthalenesulfonic acids and formaldehyde. Particularly desirable polynaphthalenesulfonates include sodium and calcium naphthalenesulfonate. The average molecular weight of the naphthalenesulfonates can range from about 3,000 to 20,000, although it is preferred that the molecular weight be about 8,000 to 10,000. A higher molecular weight dispersant has higher viscosity, and generates a higher water demand in the formulation. Useful naphthalenesulfonates include DILOFLO, available from GEO Specialty Chemicals, Cleveland, Ohio; DAXAD, available from Hampshire Chemical Corp., Lexington, Mass.; and LOMAR D, available from GEO Specialty Chemicals, Lafayette, Ind. The naphthalenesulfonates are preferably used as aqueous solutions in the range 35-55% by weight solids content, for example. It is most preferred to use the naphthalenesulfonates in the form of an aqueous solution, for example, in the range of about 40-45% by weight solids content. Alternatively, where appropriate, the naphthalenesulfonates can be used in dry solid or powder form.

The polynaphthalenesulfonates useful in the present invention have the general structure (I): 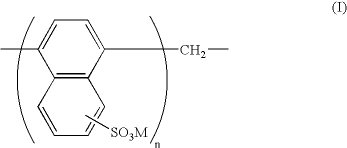
wherein n is >2, and wherein M is sodium, potassium, calcium, and the like.

The naphthalenesulfonate dispersant, preferably as an about 45% by weight solution in water, must be used in a range of from about 0.5% to about 2.5% by weight based on the weight of dry stucco used in the gypsum composite formulation. A more preferred range of naphthalenesulfonate dispersant is from about 0.5% to about 1.5% by weight based on the weight of dry stucco, and a most preferred range from about 0.7% to about 1.5% by weight based on the weight of dry stucco.

Stated in an another way, the naphthalenesulfonate dispersant, on a dry weight basis, must be used in a range from about 0.1% to about 3.0% by weight based of the weight of dry stucco used in the gypsum composite formulation. A more preferred range of naphthalenesulfonate dispersant, on a dry solids basis, is from about 0.25% to about 2.0% by weight based on the weight of dry stucco, and a most preferred range (on a dry solids basis) from about 0.3% to about 0.7% by weight based on the weight of dry stucco.

Any suitable water-soluble metaphosphate or polyphosphate can be used in accordance with the present invention. It is preferred that a trimetaphosphate salt be used, including double salts, that is trimetaphosphate salts having two cations. Particularly useful trimetaphosphate salts include sodium trimetaphosphate, potassium trimetaphosphate, calcium trimetaphosphate, sodium calcium trimetaphosphate, lithium trimetaphosphate, ammonium trimetaphosphate, and the like, or combinations thereof A preferred trimetaphosphate salt is sodium trimetaphosphate. It is preferred to use the trimetaphosphate salt as an aqueous solution, for example, in the range of about 10-15% by weight solids content. Other cyclic or acyclic polyphosphates can also be used, as described in U.S. Pat. No. 6,409,825 to Yu et al., herein incorporated by reference.

Sodium trimetaphosphate is a known additive in gypsum-containing compositions, although it is generally used in a range of from about 0.05% to about 0.08% by weight based on the weight of dry stucco used in the gypsum slurry. In embodiments of the present invention, sodium trimetaphosphate (or other water-soluble metaphosphate or polyphosphate) must be present in the range of from about 0.12% to about 0.4% by weight based on the weight of dry stucco used in the gypsum composite formulation. A preferred range of sodium trimetaphosphate (or other water-soluble metaphosphate or polyphosphate) is from about 0.12% to about 0.3% by weight based on the weight of dry stucco used in the gypsum composite formulation.

There are two forms of stucco, alpha and beta. These two types of stucco are produced by different means of calcination. In the present inventions either the beta or the alpha form of stucco may be used.

Starches, including pregelatinized starch in particular, can be used in gypsum-containing slurries prepared in accordance with the present invention. A preferred pregelatinized starch is pregelatinized corn starch, for example pregelatinized corn flour available from Bunge Milling, St. Louis, Mo., having the following typical analysis: moisture 7.5%, protein 8.0%, oil 0.5%, crude fiber 0.5%, ash 0.3%; having a green strength of 0.48 psi; and having a loose bulk density of 35.0 lb/ft³. Pregelatinized corn starch can be used in an amount up to about 10% by weight, based on the weight of dry stucco used in the gypsum-containing slurry.

Other useful starches include acid-modifed starches, such as acid-modified corn flour, available as HI-BOND from Bunge Milling, St. Louis, Mo. This starch has the following typical analysis: moisture 10.0%, oil 1.4%, solubles 17.0%, alkaline fluidity 98.0%, loose bulk density 30 lb/ft³, and a 20% slurry producing a pH of 4.3. Another useful starch is non-pregelatinized wheat starch, such as ECOSOL-45, available from ADM/Ogilvie, Montreal, Quebec, Canada, having maximum solubles 25.0%.

Accelerators can be used in the gypsum-containing compositions of the present invention, as described in U.S. Pat. No. 6,409,825 to Yu et al., herein incorporated by reference. One desirable heat resistant accelerator (HRA) can be made from the dry grinding of landplaster (calcium sulfate dihydrate). Small amounts of additives (normally about 5% by weight) such as sugar, dextrose, boric acid, and starch can be used to make this HRA. Sugar or dextrose are currently preferred. Another useful accelerator is “climate stabilized accelerator” or “climate stable accelerator,” (CSA) as described in U.S. Pat. No. 3,573,947, herein incorporated by reference.

The following examples further illustrate the invention. They should not be construed as in any way limiting the scope of the invention.

### EXAMPLE 1

Sample Gypsum Slurry Formulations

Gypsum slurry formulations are shown in Table 1 below. All values in Table 1 are expressed as weight percent based on the weight of dry stucco. Values in parentheses are dry weight in pounds (lb/MSF).

TABLE 1

| | | |
|---|---|---|
| Component | Formulation A | Formulation B |

| | | | | |
|---|---|---|---|---|
| Stucco (lb/MSF) | | (732) | | (704) |
| sodium | 0.20 | (1.50) | 0.30 | (2.14) |
| trimetaphosphate | | | | |
| Dispersant | 0.18 | (1.35) | 0.58 ¹ | (4.05) |
| (naphthalenesulfonate) | | | | |
| Pregelatinized starch | 2.7 | (20) | 6.4 | (45) |
| Board starch | 0.41 | (3.0) | 0 | |
| Heat resistant | | (15) | | (15) |
| accelerator (HRA) | | | | |
| Glass fiber | 0.27 | (2.0) | 0.28 | (2.0) |
| Paper fiber | 0 | | 0.99 | (7.0) |
| Soap* | 0.03 | (0.192) | 0.03 | (0.192) |
| Total Water (lb.) | 805 | | 852 | |
| Water/Stucco ratio | 1.1 | | 1.2 | |

*Used to pregenerate foam.
¹ 1.28% by weight as a 45% aqueous solution.

### EXAMPLE 2

Preparation of Wallboards

Sample gypsum wallboards were prepared in accordance with U.S. Pat. No. 6,342,284 to Yu et al. and U.S. Pat. No. 6,632,550 to Yu et al., herein incorporated by reference. This includes the separate generation of foam and introduction of the foam into the slurry of the other ingredients as described in Example 5 of these patents.

Test results for gypsum wallboards made using the Formulations A and B of Example 1, and a control are shown in Table 2 below. As in this example and other examples below, nail pull resistance, core hardness, and flexural strength tests were performed according to ASTM C-473. Additionally, it is noted that typical gypsum wallboard is approximately ½ inch thick and has a weight of between about 1600 to 1800 pounds per 1,000 square feet of material, or lb/MSF. (“MSF” is a standard abbreviation in the art for a thousand square feet; it is an area measurement for boxes, corrugated media and wallboard.)

TABLE 2

| | Control | Formulation | Formulation |
|---|---|---|---|
| Lab test result | Board | A Board | B Board |
| Board weight (lb/MSF) | 1587 | 1066 | 1042 |
| Nail pull resistance (lb) | 81.7 | 50.2 | 72.8 |
| Core hardness (lb) | 16.3 | 5.2 | 11.6 |
| Humidified bond load (lb) | 17.3 | 20.3 | 15.1 |
| Humidified bond failure (%) | 0.6 | 5 | 11.1 |
| Flexural strength, face-up | 47 | 47.2 | 52.6 |
| (MD) (lb) | | | |
| Flexural strength, face-down | 51.5 | 66.7 | 78.8 |
| (MD) (lb) | | | |
| Flexural strength, face-up | 150 | 135.9 | 173.1 |
| (XMD) (lb) | | | |
| Flexural strength, face-down | 144.4 | 125.5 | 165.4 |
| (XMD) (lb) | | | |

MD: machine direction
XMD: across machine direction

As illustrated in Table 2, gypsum wallboards prepared using the Formulation A and B slurries have significant reductions in weight compared to the control board. With reference again to Table 1, the comparisons of the Formulation A board to the Formulation B board are most striking. The water/stucco (w/s) ratios are similar in Formulation A and Formulation B. A significantly higher level of naphthalenesulfonate dispersant is also used in Formulation B. Also, in Formulation B substantially more pregelatinized starch was used, about 6% by weight, a greater than 100% increase over Formulation A accompanied by marked strength increases. Even so, the water demand to produce the required flowability remained low in the Formulation B slurry, the difference being less than 10% in comparison to Formulation A. The low water demand in both Formulations is attributed to the synergistic effect of the combination of naphthalenesulfonate dispersant and sodium trimetaphosphate in the gypsum slurry, which increases the fluidity of the gypsum slurry, even in the presence of a substantially higher level of pregelatinized starch.

As illustrated in Table 2, the wallboard prepared using the Formulation B slurry has substantially increased strength compared with the wallboard prepared using the Formulation A slurry. By incorporating increased amounts of pregelatinized starch in combination with increased amounts of naphthalenesulfonate dispersant and sodium trimetaphosphate, nail pull resistance in the Formulation B board improved by 45% over the Formulation A board. Substantial increases in flexural strength were also observed in the Formulation B board as compared to the Formulation A board.

### EXAMPLE 3

½ Inch Gypsum Wallboard Weight Reduction Trials

Further gypsum wallboard examples (Boards C, D and E), including slurry formulations and test results are shown in Table 3 below. The slurry formulations of Table 3 include the major components of the slurries. Values in parentheses are expressed as weight percent based on the weight of dry stucco.

TABLE 3

| Trial | | | | |
|---|---|---|---|---|
| formulation | | | | |
| component/ | Control | Formulation | Formulation | Formulation |
| parameter | Board | C Board | D Board | E Board |
| Dry stucco | 1300 | 1281 | 1196 | 1070 |
| (lb/MSF) | | | | |
| Accelerator | 9.2 | 9.2 | 9.2 | 9.2 |
| (lb/MSF) | | | | |
| DILOFLO ¹ | 4.1 (0.32%) | 8.1 (0.63%) | 8.1 (0.68%) | 8.1 (0.76%) |
| (lb/MSF) | | | | |
| Regular | 5.6 (0.43%) | 0 | 0 | 0 |
| starch | | | | |
| (lb/MSF) | | | | |
| Pregelatinized | 0 | 10 (0.78%) | 10 (0.84%) | 10 (0.93%) |
| corn starch | | | | |
| (lb/MSF) | | | | |
| Sodium tri- | 0.7 (0.05%) | 1.6 (0.12%) | 1.6 (0.13%) | 1.6 (0.15%) |
| metaphosphate | | | | |
| (lb/MSF) | | | | |
| Total water/ | 0.82 | 0.82 | 0.82 | 0.84 |
| stucco ratio | | | | |
| (w/s) | | | | |
| Trial | | | | |
| formulation | | | | |
| test results | | | | |
| Dry board | 1611 | 1570 | 1451 | 1320 |
| weight | | | | |
| (lb/MSF) | | | | |
| Nail pull | 77.3^{†} | 85.5 | 77.2 | 65.2 |
| resistance | | | | |
| (lb) | | | | |

^{†}ASTM standard: 77 lb
¹ DILOFLO is a 45% Naphthalensulfonate solution in water

As illustrated in Table 3, Boards C, D, and E were made from a slurry having substantially increased amounts of starch, DILOFLO dispersant, and sodium trimetaphosphate in comparison with the control board (about a two-fold increase on a percentage basis for the starch and dispersant, and a two- to three-fold increase for the trimetaphosphate), while maintaining the w/s ratio constant. Nevertheless, strength as measured by nail pull resistance was not dramatically affected and board weight was significantly reduced. Therefore, in this example of an embodiment of the invention, the new formulation (such as, for example, Board D) can provide increased starch formulated in a usable, flowable slurry, while maintaining adequate strength.

### EXAMPLE 4

Wet Gypsum Cube Strength Test

The wet cube strength tests were carried out by using Southard CKS board stucco, available from United States Gypsum Corp., Chicago, Ill. and tap water in the laboratory to determine their wet compressive strength. The following lab test procedure was used.

Stucco (1000 g), CSA (2 g), and tap water (1200 cc) at about 70° F. were used for each wet gypsum cube cast. Pregelatinized corn starch (20 g, 2.0% based on stucco wt.) and CSA (2 g, 0.2% based on stucco wt.) were thoroughly dry mixed first in a plastic bag with the stucco prior to mixing with a tap water solution containing both naphthalenesulfonate dispersant and sodium trimetaphosphate. The dispersant used was DILOFLO dispersant (1.0-2.0%, as indicated in Table 4). Varying amounts of sodium trimetaphosphate were used also as indicated in Table 4.

The dry ingredients and aqueous solution were initially combined in a laboratory Warning blender, the mixture produced allowed to soak for 10 sec, and then the mixture was mixed at low speed for 10 sec in order to make the slurry. The slurries thus formed were cast into three 2″×2″×2″ cube molds. The cast cubes were then removed from the molds, weighed, and sealed inside plastic bags to prevent moisture loss before the compressive strength test was performed. The compressive strength of the wet cubes was measured using an ATS machine and recorded as an average in pounds per square inch (psi). The results obtained were as follows:

TABLE 4

| | | | DILOFLO ¹ | | Wet cube |
|---|---|---|---|---|---|
| Test | Sodium | | (wt % | Wet cube | compres- |
| Sam- | trimetaphosphate, | | based on | weight | sive |
| ple | grams (wt % based | | dry | (2″ × 2″ × 2″), | strength, |
| No. | on dry stucco) | | stucco) | g | psi |
| 1 | 0 | | 1.5 | 183.57 | 321 |
| 2 | 0.5 | (0.05) | 1.5 | 183.11 | 357 |
| 3 | 1 | (0.1) | 1.5 | 183.19 | 360 |
| 4 | 2 | (0.2) | 1.5 | 183.51 | 361 |
| 5 | 4 | (0.4) | 1.5 | 183.65 | 381 |
| 6 | 10 | (1.0) | 1.5 | 183.47 | 369 |
| 7 | 0 | | 1.0 | 184.02 | 345 |
| 8 | 0.5 | (0.05) | 1.0 | 183.66 | 349 |
| 9 | 1 | (0.1) | 1.0 | 183.93 | 356 |
| 10 | 2 | (0.2) | 1.0 | 182.67 | 366 |
| 11 | 4 | (0.4) | 1.0 | 183.53 | 365 |
| 12 | 10 | (1.0) | 1.0 | 183.48 | 341 |
| 13 | 0 | | 2.0 | 183.33 | 345 |
| 14 | 0.5 | (0.05) | 2.0 | 184.06 | 356 |
| 15 | 1 | (0.1) | 2.0 | 184.3 | 363 |
| 16 | 2 | (0.2) | 2.0 | 184.02 | 363 |
| 17 | 4 | (0.4) | 2.0 | 183.5 | 368 |
| 18 | 10 | (1.0) | 2.0 | 182.68 | 339 |

¹ DILOFLO is a 45% Naphthalensulfonate solution in water

As illustrated in Table 4, Samples 4-5, 10-11, and 17, having levels of sodium trimetaphosphate in the about 0.12-0.4 % range of the present invention generally provided superior wet cube compressive strength as compared to samples with sodium trimetaphosphate outside this range.

### EXAMPLE 5

½ Inch Light Weight Gypsum Wallboard Plant Production Trials

Further trials were performed (Trial Boards 1 and 2), including slurry formulations and test results are shown in Table 5 below. The slurry formulations of Table 5 include the major components of the slurries. Values in parentheses are expressed as weight percent based on the weight of dry stucco.

TABLE 5

| | | Plant | | Plant |
|---|---|---|---|---|
| Trial formulation | Control | Formulation | Control | Formulation |
| component/parameter | Board 1 | Trial Board 1 | Board 2 | Trial Board 2 |
| Dry stucco (lb/MSF) | 1308 | 1160 | 1212 | 1120 |
| DILOFLO ¹ (lb/MSF) | 5.98 (0.457%) | 7.98 (0.688%) | 7.18 (0.592%) | 8.99 (0.803%) |
| Regular starch (lb/MSF) | 5.0 (0.38%) | 0 | 4.6 (0.38%) | 0 |
| Pregelatinized corn starch | 2.0 (0.15%) | 10 (0.86%) | 2.5 (0.21%) | 9.0 (0.80%) |
| (lb/MSF) | | | | |
| Sodium trimetaphosphate | 0.7 (0.05%) | 2.0 (0.17%) | 0.6 (0.05%) | 1.6 (0.14%) |
| (lb/MSF) | | | | |
| Total water/stucco ratio | 0.79 | 0.77 | 0.86 | 0.84 |
| (w/s) | | | | |
| Trial formulation | | | | |
| test results | | | | |
| Dry board weight | 1619 | 1456 | 1553 | 1443 |
| (lb/MSF) | | | | |
| Nail pull resistance (lb) | 81.5^{†} | 82.4 | 80.7 | 80.4 |
| Flexural strength, | 41.7 | 43.7 | 44.8 | 46.9 |
| average (MD) (lb) | | | | |
| Flexural strength, | 134.1 | 135.5 | 146 | 137.2 |
| average (XMD) (lb) | | | | |
| Humidified bond ² load, | 19.2 | 17.7 | 20.9 | 19.1 |
| average (lb) | | | | |
| Humidified bond ^{2, 3} | 1.6 | 0.1 | 0.5 | 0 |
| failure (%) | | | | |

^{†}ASTM standard: 77 lb
MD: machine direction
XMD: across machine direction
¹ DILOFLO is a 45% Naphthalensulfonate solution in water
² 90° F./90% Relative Humidity
³ It is well understood that under these test conditions, percentage failure rates <50% are acceptable.

As illustrated in Table 5, Trial Boards 1 and 2 were made from a slurry having substantially increased amounts of starch, DILOFLO dispersant, and sodium trimetaphosphate in comparison with the control boards while maintaining the w/s ratio constant. Nevertheless, strength as measured by nail pull resistance and flexural testing was maintained or improved, and board weight was significantly reduced. Therefore, in this example of an embodiment of the invention, the new formulation (such as, for example, Trial Boards 1 and 2) can provide increased trimetaphosphate and starch formulated in a usable, flowable slurry, while maintaining adequate strength.

### EXAMPLE 6

½ Inch Ultra-Light Weight Gypsum Wallboard Plant Production Trials

Further trials were performed (Trial Boards 3 and 4) using Formulation B (Example 1) as in Example 2, except that the pregelatinized corn starch was prepared with water at 10% concentration (wet starch preparation) and a blend of HYONIC PFM soaps (available from GEO Specialty Chemicals, Lafayette, Ind.) was used. For example, Trial Board 3 was prepared with a blend of HYONIC PFM 10/HYONIC PFM 33 ranging from 65-70% by weight/35-30% by weight. For example, Trial Board 4 was prepared with a 70/30 wt./wt. blend of HYONIC PFM 10/HYONIC PFM 33. The trial results are shown in Table 6 below.

TABLE 6

| | Trial Board 3 | Trial Board 4 |
|---|---|---|
| | (Formulation B plus | (Formulation B plus |
| | HYONIC soap blend | HYONIC soap blend |
| | 65/35) | 70/30) |
| Lab test result | (n = 12) | (n = 34)* |
| Board weight (lb/MSF) | 1106 | 1013 |
| Nail pull resistance^{a} (lb) | 85.5 | 80.3 |
| Core hardness^{b} (lb) | 12.4 | >15 |
| Flexural strength, | 55.6 | 60.3 ¹ |
| average^{c} (MD) (lb) | | |
| Flexural strength, | 140.1 | 142.3 ¹ |
| average^{d} (XMD) (lb) | | |

*Except as marked.
¹ n = 4
MD: machine direction
XMD: across machine direction
^{a}ASTM standard: 77 lb
^{b}ASTM standard: 11 lb
^{c}ASTM standard: 36 lb
^{d}ASTM standard: 107 lb

As illustrated in Table 6, strength characteristics as measured by nail pull and core hardness were above the ASTM standard. Flexural strength was also measured to be above the ASTM standard. Again, in this example of an embodiment of the invention, the new formulation (such as, for example, Trial Boards 3 and 4) can provide increased trimetaphosphate and starch formulated in a usable, flowable slurry, while maintaining adequate strength.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A gypsum-containing slurry comprising: water, stucco, sodium trimetaphosphate, and a naphthalenesulfonate dispersant, wherein the sodium trimetaphosphate is present in an amount of at least about 0.12% by weight based on the weight of stucco.

2. The gypsum-containing slurry of claim 1, wherein the naphthalenesulfonate dispersant is present in an amount from about 0.1% to about 3.0% by weight based on the weight of stucco.

3. The gypsum-containing slurry of claim 1, wherein the naphthalenesulfonate dispersant is present in an amount from about 0.25% to about 2.0% by weight based on the weight of stucco.

4. The gypsum-containing slurry of claim 1, wherein the naphthalenesulfonate dispersant is present in an amount from about 0.3% to about 0.7% by weight based on the weight of stucco.

5. The gypsum-containing slurry of claim 1, wherein the naphthalenesulfonate dispersant is in the form of an aqueous solution containing about 40% to about 45% by weight naphthalenesulfonate and the aqueous solution is present in an amount from about 0.5% to about 2.5% by weight based on the weight of stucco.

6. The gypsum-containing slurry of claim 1, wherein the naphthalenesulfonate dispersant is in the form of an aqueous solution containing about 40% to about 45% by weight naphthalenesulfonate and the aqueous solution is present in an amount from about 0.5% to about 1.5% by weight based on the weight of stucco.

7. The gypsum-containing slurry of claim 1, wherein the naphthalenesulfonate dispersant is in the form of an aqueous solution containing about 40% to about 45% by weight naphthalenesulfonate and the aqueous solution is present in an amount from about 0.7% to about 1.5% by weight based on the weight of stucco.

8. A gypsum wallboard comprising:
a set gypsum composition formed between two substantially parallel cover sheets, the set gypsum composition made using a gypsum-containing slurry comprising:
water, stucco, sodium trimetaphosphate, and a naphthalenesulfonate dispersant, wherein the sodium trimetaphosphate is present in an amount of at least about 0.12% by weight based on the weight of stucco.

9. The gypsum wallboard of claim 8, wherein the naphthalenesulfonate dispersant is present in an amount from about 0.1% to about 3.0% by weight based on the weight of stucco.

10. The gypsum wallboard of claim 8, wherein the naphthalenesulfonate dispersant is present in an amount from about 0.25% to about 2.0% by weight based on the weight of stucco.

11. The gypsum wallboard of claim 8, wherein the naphthalenesulfonate dispersant is present in an amount from about 0.3% to about 0.7% by weight based on the weight of stucco.

12. The gypsum wallboard of claim 8, wherein the naphthalenesulfonate dispersant is in the form of an aqueous solution containing about 40% to about 45% by weight naphthalenesulfonate and the aqueous solution is present in an amount from about 0.5% to about 2.5% by weight based on the weight of stucco.

13. The gypsum wallboard of claim 8, wherein the naphthalenesulfonate dispersant is in the form of an aqueous solution containing about 40% to about 45% by weight naphthalenesulfonate and the aqueous solution is present in an amount from about 0.5% to about 1.5% by weight based on the weight of stucco.

14. The gypsum wallboard of claim 8, wherein the naphthalenesulfonate dispersant is in the form of an aqueous solution containing about 40% to about 45% by weight naphthalenesulfonate and the aqueous solution is present in an amount from about 0.7% to about 1.5% by weight based on the weight of stucco.

15. A method of making gypsum wallboard, comprising the steps of:
(a) mixing a gypsum-containing slurry comprising
water, stucco, sodium trimetaphosphate, and a naphthalenesulfonate dispersant,
wherein the sodium trimetaphosphate is present in an amount of at least about 0.12% by weight based on the weight of stucco;
(b) depositing the gypsum-containing slurry on a first cover sheet;
(c) placing a second cover sheet over the deposited slurry to form a gypsum wallboard;
(d) cutting the gypsum wallboard after the gypsum-containing slurry has hardened sufficiently for cutting; and
(e) drying the gypsum wallboard.

16. The method of claim 15, in which the first cover sheet and the second cover sheet are made of paper.

17. The method of claim 15, wherein sodium trimetaphosphate is present in an amount from about 0.12% to about 0.4% by weight based on the weight of stucco, and the naphthalenesulfonate dispersant is present in an amount from about 0.1% to about 3.0% by weight based on the weight of stucco.

18. The method of claim 15, wherein sodium trimetaphosphate is present in an amount from about 0.12% to about 0.4% by weight based on the weight of stucco, and the naphthalenesulfonate dispersant is in the form of an aqueous solution containing about 40% to about 45% by weight naphthalenesulfonate and the aqueous solution is present in an amount from about 0.5% to about 2.5% by weight based on the weight of stucco.
